(19) United States
(12) Patent Application Publication
(10) Pub. No.: US 2006/0294058 A1
(43) Pub. Date: Dec. 28, 2006

(54) System and method for an asynchronous queue in a database management system

(75) Inventors: Peter Zabback, Kirkland, WA (US); Conor J. Cunningham, Redmond, WA (US); Keith Elmore, Southlake, TX (US); Marc T. Friedman, Seattle, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/169,064

(22) Filed: Jun. 28, 2005

(51) Int. Cl. G06F 17/30

(52) U.S. Cl. 707/2

(57) ABSTRACT

A method for performing asynchronous statistics updates in a database management system includes receiving a first query against the database, determining if present statistics related to the first query are stale and entering on a queue a request to acquire updated statistics if the present statistics are stale. The queue jobs are executed asynchronously with respect to the query request. As a result, a first query plan may be developed using the present statistics related to the first query. Thus, no delay in processing the query due to statistics updates is incurred. The first query plan may be executed and results given to the requester. At some later time, the request to acquire updated statistics related to the first query is processed asynchronously from the query request. If subsequent queries are received, the queue can delete duplicate requests to update the same statistics. Those subsequent queries can benefit from the updated statistics.

### FIELD OF THE INVENTION

The invention relates generally to the field of optimization of software queries, and more particularly to asynchronously performing statistics updates.

### BACKGROUND OF THE INVENTION

Database management systems (DBMS) are ubiquitous and may run as servers. In operation, clients connect to the DBMS and send a series of commands, possibly in the form of SQL queries, that operate on the data and return the resulting sets of rows. Client requests to a DBMS have a certain rhythm. For example, a user may request access to a database and initiate security checks before a connection is established. A query may be generated and the transactions get started, a query, possibly in SQL code, gets parsed, compiled and optimized, and executed. Generally, the results and result sets get fetched by the client. The server's activity includes work for query requests and the resulting activity.

The query optimizer is the part of compilation pipeline that converts a logical representation, such as a SQL statement, of a client query into an execution plan. Static properties of the database, such as the types of tables and the indexes available, are not generally sufficient to produce high quality executions plan selections. Modern query optimizers rely on cost-based plan selection, in which estimates of the data distributions and correlations are used to determine which plans will be more efficient. The lowest cost solution, in terms of the use of computer resources such as computer cycles and memory, is the goal of plan selection. Deriving and maintaining statistical information about the dynamic state of the table data, to be used in cost estimation, has been a major area of database research. In particular, the need for histograms on single columns is recognized and many variants of histograms and supplements to histograms have been applied over the years.

Today, most commercially available database management systems incorporate an automatic decision to create table and column statistics and decide when to update them. However, the automatic decision to update a particular histogram, and the actual update of the histogram, can currently occur during the client request that triggered them. This leads to large wait times even for small queries.

FIG. 1a depicts an example of a typical prior art DBMS query response timeline. In the timeline, a query is received 10 and the DBMS checks for statistics to use to assist in the development or selection of a query plan. If new statistics are needed on the table columns that are involved in the query, an update to the statistics 12 is undertaken. Afterwards, a query plan is developed using the updated statistics 14 and the plan is executed 16. Finally, results are returned reflecting the query. As can be seen in FIG. 1b, if updated statistics are not needed, then the cycle of receiving the query 11, developing the plan 13, executing the plan 17 and returning the results requires less time, and hence less CPU cycles than when a statistics update is required.

This prior art scheme has several disadvantages. For the client of the SQL server, the prior art scheme requires expensive computer resource processing of statistics before returning query results. For the system as a whole, it means that there is no way to smooth out processing to make use of dead times to prepare for busy times.

Thus it would be advantageous to develop a scheme to avoid the processing of statistics synchronously with query requests. The invention addresses the aforementioned needs and solves them with various systems, methods and techniques that also offer other advantages for optimizing query response time.

### SUMMARY OF THE INVENTION

The invention solves the problem of unpredictable delays in processing a query against a database due to statistics updates. Present database management systems process statistics updates synchronously with the query; getting new statistics first and thus delaying the processing of the query. In one aspect of the present invention an asynchronous queue is employed to accept a request for a statistics update and decouple the statistics update from the processing of the original query request. The query is processed using the pre-existing or present statistics instead of using updated statistics. In another aspect of the invention, automatic index creation may also be accomplished in a manner similar to that of statistics updates using an asynchronous queue.

In one aspect of the invention, the queue can detect and eliminate duplicate requests for the same statistics update to better utilize computer resources. In another aspect, a cache of stored query execution plans may be accessed to determine if a submitted query has already been developed. In this instance, a determination is made to use the cached plan or develop a new one if statistics are available that are newer than those used to develop it. In another aspect, a determination is made to put a request on the asynchronous queue to prepare updated statistics for future use. The asynchronous request may be executed independently of the query request. Thus, there is no unpredictable delay in processing a query request as a result of a statistics update.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1a is an example prior art timeline of query processing in a DMBS;

FIG. 1b is an example timeline if a statistics update were not required;

FIG. 1c is an example timeline of multiple thread timelines according to aspects of the invention;

FIG. 2a depicts an exemplary block diagram architecture in which aspects of the invention may be implemented;

FIG. 2b depicts an exemplary block diagram architecture in which aspects of the invention may be implemented; and

FIG. 3 is a block diagram showing an exemplary computing environment in which aspects of the invention may be implemented.

### DETAILED DESCRIPTION OF ILLUSTRATIVE EMBODIMENTS

Current DBMS optimization processes introduce various sources of response-time unpredictability. Expensive computer resource operations such as updating statistics, creating statistics, and recompiling, are triggered as needed according to search requirements of the query. For example, the query that triggers the time and resource expensive operations has to wait until the extra process of statistics update is complete before processing to provide query results. This makes total response times unpredictable and causes applications with aggressive timeouts to fail in the field.

For example, consider the case where a DBMS customer has a large and growing database table. Many single-row updates, inserts, and queries may happen per second. The customer application may use a DBMS such as SQL Server® available from Microsoft® in Redmond, Wash. The customer application may call the DBMS with 10 second timeouts, since all of its queries are simple. Whenever a query comes in, the DBMS checks to see if any of the statistics the query depends on are deemed stale. For example, stale statistics (stats) may be defined as statistics whose leading column has had more row modifications than are tolerated, given the cardinality of the table. This may be determined by a complex formula, but for simplicity of example, the threshold may be determined as 20% of the cardinality of the table. If, in this case, approximately 20% of the table has been updated since the statistics were created, then the statistics may be considered stale. If so, the query triggers a statistics update.

In the example, the customer DBMS works as expected for over a year, because the statistics updates take under 9 seconds. But as the customer table grows to over 100 million rows, the statistics update starts to take longer. At one point the 10 second threshold is crossed. The next statistics update starts, but is rolled back when the client timeout kills the request. The query rolls back all its work, including the statistics update, which was almost finished, and returns an error to the application. Then the next query triggers a statistics update also, rolls back, and the repeats due to the timeout. As a result, all clients can get shut out of the table, and one thread in the database is perpetually doing statistics updates that never finish. Hence, the customer DBMS is rendered unproductive.

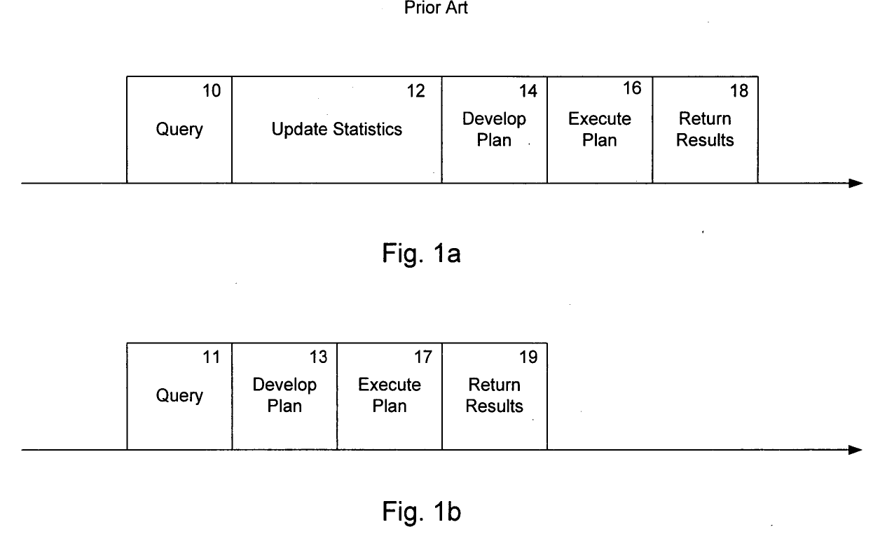

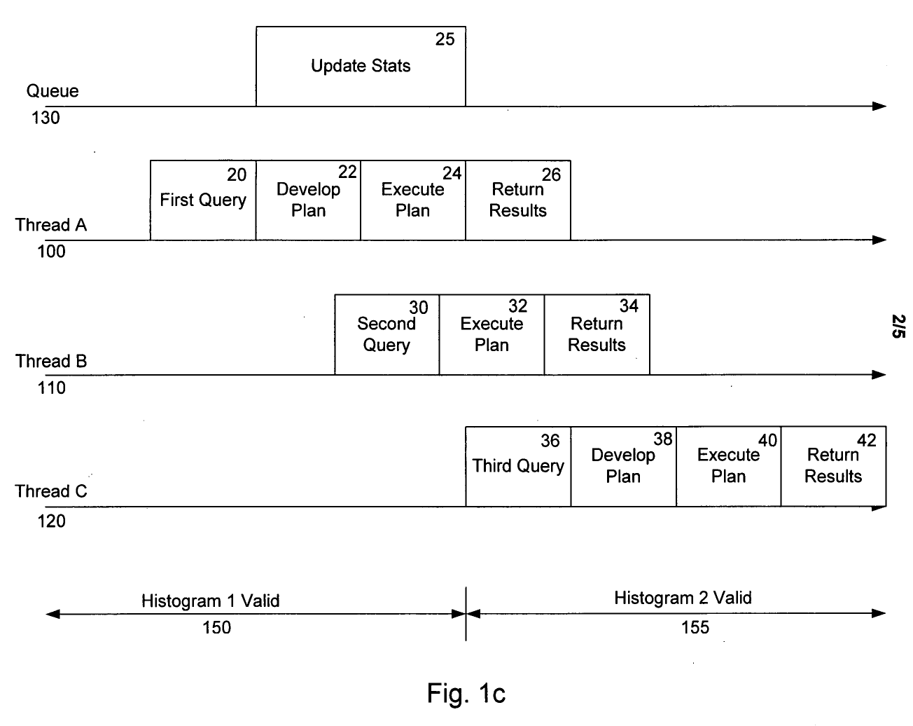

According to an aspect of the invention, if the statistics update were to occur asynchronously with respect to the query request, then the response time to the request would become more predictable. FIG. 1c depicts aspects of an example asynchronous operation of the invention. FIG. 1c indicates three threads 100, 110 and 120 respectively. Thread A 100 occurs first in time. In the example, a first query, 20 is received and the DBMS determines that the statistics related to the first query are stale. According to an aspect of the invention, a request to acquire updated statistics related to the first query is place on a queue 130 which operates asynchronously to thread A 100. The first query thread A can then use existing or the presently existing statistics, such as histogram 1 (150) to develop a query plan 22. After the query plan 22 is developed, it can be executed 24 and results returned 26 to the requestor. As a aspect of the invention, the request for updated statistics 25 on queue 130 may be executed at any time with respect to the trigger first query 20 occurring on thread A.

As is characteristic of many database management systems, multiple parallel threads may occur simultaneously. For example, while thread A 100 is underway, thread B 110 may be initiated as a second query 30. For purposes of the example, assume that the second query 30 uses the same statistics as the first query 20. Since updated statistics are not yet available for the second query 30 to use, the second query can also use histogram 1 (150). According to an aspect of the invention, a cache (not shown) of plans may be checked by the DBMS to avoid the re-compiling of a query plan. It is assumed here that the first query plan 22 may be used for the second query execution 32 to produce return results 34 in thread B 110.

According to another aspect of the invention, if thread B 110 also decided to generate a statistics update 25 for the relevant columns and tables, then a new queue 130 entry would be generated. However, that new entry (not shown) would be a duplicate of the entry 25 already in the queue 130. According to an aspect of the invention, duplicate queue entries may be deleted to as the make the queue efficient.

Assuming that the job 25 of updating the statistics for tables related to the first query is completed, then an updated set of statistics, histogram 2 (155) is available. If thread C (155) is initiated which can use at least the updated statistics 25 of the first query 20, then thread C (155) can benefit from the development of histogram 2 (155). In this portion of the example, the third query 36 is assumed to have some portion which can use the updated statistics of histogram 2 (155). A query plan 38 can then be developed using histogram 2 (155) data and the plan can be executed 40. The return results 42 are then provided to the requestor in a predictable time frame. This new plan becomes cached for future use in place of the previous one.

In general, stale statistics are put on a queue for execution by a worker thread. In one embodiment, there is one such queue in the system for this purpose, and any thread having a query can queue work to it. The query, and any other queries that are concurrent with it, uses the stale statistics. That request may be picked off the queue by a background thread. Queries that begin after the updated statistics are ready use those updated statistics instead of the previous ones. That means that if a cached plan depends on version N, and version N+1 is ready, the query throws out the cached plan and recompiles with version N+1. The timeline of FIG. 1c illustrates a few aspects of the invention. Asynchronous statistics rebuild jobs 25 from the queue 130 can begin asynchronously without being synchronously tied to a query request. The queue 130 can prevent duplicate jobs from being queued. Since the expensive statistics rebuilds 25 have been decoupled from the query requests 20 and 30, stale statistics (histogram 1) are used to process the request rather than wait for a computation of updated statistics (histogram 2). As an advantage, asynchronous statistics update can avoid the occasional long compiles seen by a query requestor; dramatically improving the predictability of simple query response times. The statistics updates are removed from the client-servicing thread.

In one embodiment, a basic job queue mechanism is implemented to realize the invention. The job queue mechanism is a facility for threads of execution anywhere in the DBMS to post objects and call jobs to be executed at a later time while the threads proceed with other activities. The jobs in the queue may be processed later by other threads of execution, called background threads, which can process non-client-triggered operations in a continuous loop. In one aspect of the invention, the job queue is polymorphic, accepting multiple types of jobs defined using an extensible type system of job types, each with associated formats and processing routines.

In one embodiment, a single FIFO (first-in, first-out) queue is provided per DBMS instance. In another embodiment, the queue may be implemented using a high-performance multithreaded list. All waiting or in-progress jobs are in the queue. As an example for sizing, the queue size may be limited to 100 such that no more than 100 jobs total can be either waiting in the queue or in progress at any time. As an option, multiple queues or priority queues may be implemented to give differing levels of service. It is also an option to change or remove the queue size limit.

In one embodiment, facilities may be provided by the job queue include adding a job, reserving a job, completing a reserved job, retry of a reserved job, listing the currently queued jobs (including an job identifier chosen by the queue), and killing a job by job identifier. It is an option to use a less elaborate scheme, such as add/remove/kill, or just add/remove.

As an aspect of the invention, any thread in the DBMS may add a job, so the queue preferably has multithreaded access. Multiple background threads may process jobs concurrently, so multithreaded access to the queue may be provided as well. As an option, all operations may be implemented in such a way as not to corrupt the queue regardless of what other operations may be taking place, even as no operation prevents any other from making progress. Optional provision of fully serialized accesses to the queue is also contemplated.

According to an aspect of the invention, the queue mechanism provides duplicate prevention by entering queued jobs in a lookup table for duplicate detection. A job may contain a signature. If the signature of a job is the same as the signature of another job, they are duplicates. The signature contains a way of differentiating types of jobs, and a way of differentiating different jobs of the same type. Each job type may define its own set of identifying characteristics for a job and thus its own notion of job equality. In one embodiment, a fixed-size buffer may be used with a job type followed by a variable set of fields. Equality may be defined as bitwise equality of the buffer. As an option, other job duplication detection mechanisms may be used such as class hierarchy or specifics such as table and column identifiers for asynchronous updates. As an option, duplicate prevention may be eliminated from an implementation.

In one embodiment using a background thread as the mechanism for executing entries on the queue, the background thread first requests a job off the queue. The job may then be reserved. After the job is completed, what happens next depends on a return code which indicates success, failure or retry. If a success or failure code is returned, then the queue is informed that the job is completed, which removes it from the queue. If the retry code is returned, then the queue is informed, and the job is (atomically) moved to the back of the queue. The queue increments the jobs retry count, and if the retry count exceeds the retry limit ( for example, 10), then the job is considered complete regardless of its return code. Optionally, the retry limit may be changed or removed entirely.

In one embodiment, a kill function may be implemented to stop execution of a job. Preferably, the kill function returns only when the job has either finished or aborted. The implementation of kill, which uses a flag on the thread to send a signal to the thread, can reset the background thread to a clean state before returning it to its continuous loop.

Asynchronous activities within a DBMS may happen outside any user transaction. This leads to exception cases that may not be processed asynchronously. An exception instance case may occur during a statistics update triggered during the same transaction in which the table is created or altered; assuming the create or alter has not been committed. If there was a create, then the background activity would not be able to access the table. If there was an alter command and it is committed, it would throw away the statistics created in the background, since statistics are specific to a table version.

Database management systems have locking mechanisms to assist in maintaining consistency of the database. In one embodiment, the locking scheme in a DBMS may be adapted to prevent service degradation from asynchronous statistics update jobs. Synchronous statistics updates (which may still be used in some situations) lock the statistics that they are updating aggressively, before they begin to process it. Asynchronous jobs, on the other hand, preferably grab this lock after they have finished creating the new version of the statistics but before they save them. Asynchronous jobs use non-blocking lock acquisition, and immediately give up if they can not acquire lock.

In one embodiment, plan recompilation logic can take advantage of asynchronous statistics updates. Statistics become stale when some threshold number of row updates (or inserts or deletes) have occurred since the statistics were last built or rebuilt. The threshold may be a function of the table size. Since query processing plans are selected based on these statistics, and plans may be cached for reuse, the notion of staleness extends to plans. A plan is stale if it relies on any statistics that are stale. Staleness may be checked before executing a cached plan, and stale plans can trigger statistics updates followed by recompilation. The staleness check may be separated from the check of whether the statistics rebuild has been completed. When a plan is stale, then the stale statistics it depends on are queued for rebuild. Then, if any statistics updates have been completed by this time, because of a rebuild queued previously, then a recompile of a query plan would occur.

As an aspect of the invention, further optional extensions of the invention are contemplated. For example, the invention may include alternative statistics collection. The invention may include a job type for advanced statistics collection. Although the basic statistics framework may include collecting, for a given sequence of columns, a histogram, a density measure, and a tree to compress common substrings for string columns, it is also contemplated to collect different summary data over a single column sequence in an asynchronous manner.

In another embodiment, advanced statistics collection can measure the degree of correlation, inclusion, and functional dependency between two sequences of columns. In another embodiment, the invention may include a job type for asynchronous automated statistics creation. Statistics creation may be queued similarly as an update with the addition of locking. A deletion of statistics may also be queued although statistics deletion can be fast and non-blocking.

In another embodiment, the invention includes a job type for asynchronous automated creation and deletion of statistics over columns of views that may or may not be materialized. The difference between this and ordinary statistics creation is that the statistics are constructed over a stream of data arising from an arbitrary query over tables, filters, groupings, and orderings, rather than from a single table.

In another embodiment, the invention includes a job type for asynchronous automated index creation. Unlike statistics, which are approximate and diverge from their underlying data as updates are applied, indexes are usually, but not always, required to correctly reflect the underlying data. So in order to prevent large interruptions of service, a ‘live’ index construction algorithm may be provided that allows for updates to continue on a table when it has a partially constructed index. The asynchronous aspects of index creation are otherwise analogous to statistics creation. In index creation, an index related to a query may be determined to be missing or incomplete. Once a missing index is identified, it can be queued asynchronously.

In another embodiment, the invention includes a job type for asynchronous automated view index creation/deletion. Since indexes on views are analogous to other indexes, there is little difference between this job type and the preceding one. Again, a ‘live’ algorithm may be provided so that service is not interrupted.

Thus, the present invention is useful not only for asynchronously developing statistics for user queries in a DBMS, but also may be used to asynchronously queue a job triggered from the DBMS. Thus a database user or client machine may request or trigger a build of basic statistics without any expensive processing, and return results without any delay during the query. The basic statistics can be rebuilt at a later time, outside of any client request, without delaying any other requests. The present invention may also be used to speculatively build advanced statistics structures such as statistics on views and multicolumn summaries. Gathering statistics on (non-materialized) views is an extension of gathering statistics on tables. The stream of data rows that may be analyzed is the output of an arbitrary query plan rather than a simple table scan. Multicolumn summaries can indicate column sequence pairs with a high degree of correlation, inclusion, or functional dependency. Such multicolumn summaries are expensive to find, since there are many combinations of columns to try, most of which will have no relationship. Hence there is value in an asynchronous approach that can use the machines idle time searching for this potentially valuable information.

The present invention permits the ability to create and delete indexes and views automatically without delaying client requests. Client requests can generate plans with table accesses and subqueries that can be useful if stored as partial results. These requests update a scoreboard of potentially useful indexes and views. Periodically, the optimizer scans this structure and decides what indexes and views to create or remove. The individual creation and removal jobs occur as separate maintenance tasks handled as an asynchronous task.

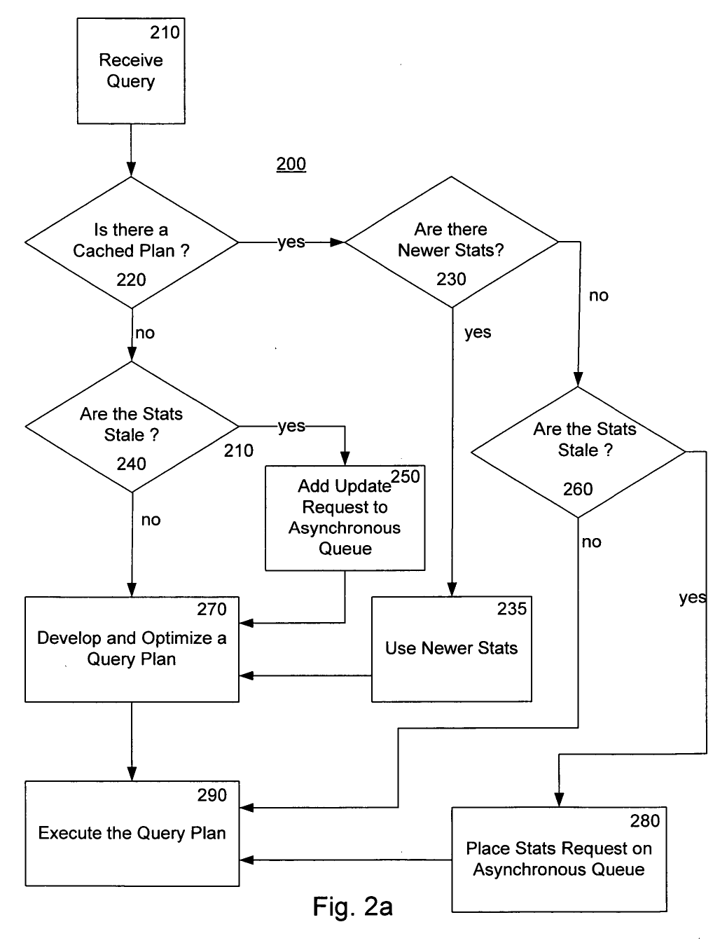

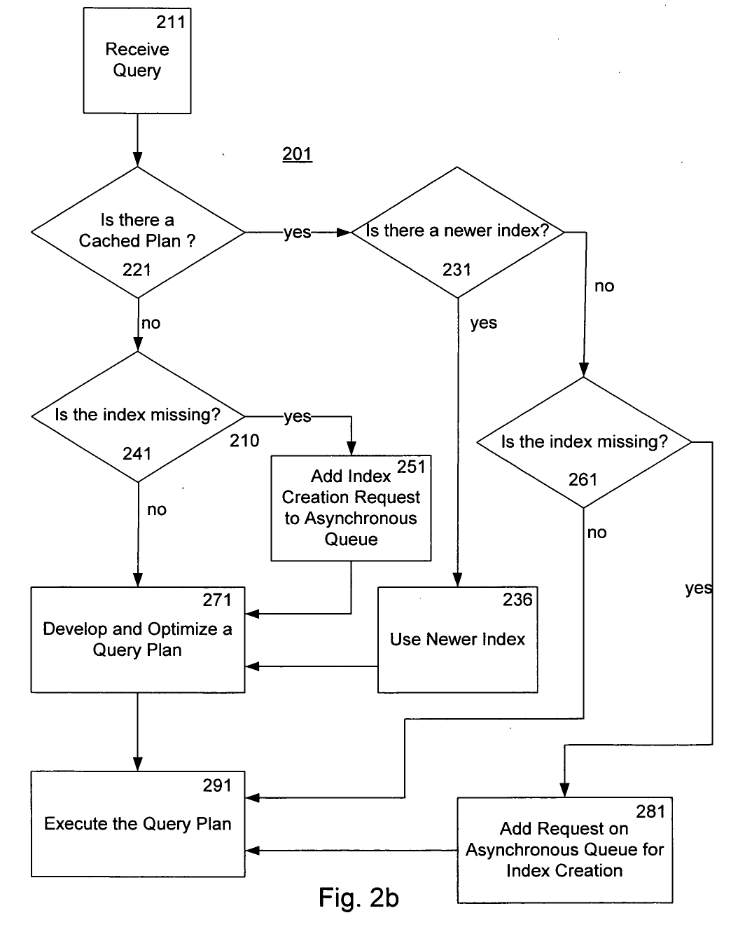

FIG. 2a is an example flow diagram of a method according to aspects of the invention. In the method 200, a query is received (step 210) in a DBMS. If the DBMS caches query plans, then the DBMS determines whether there is a cached query plan (step 220). If there is no caching in the system or if there is no cached plan in a cached system, the DBMS determines if the statistics related to the query are stale (step 240). If the statistics related to the query are stale, then the DBMS adds a request to the queue. (step 250) to asynchronously calculate statistics for the relevant table and columns for the query. Without immediately calculating the request for updated statistics, the DBMS develops and optimizes a query plan (step 270) using the presently available but stale statistics. The DBMS is then free to execute the query plan (step 290) and return results of the query. Alternately, if the statistics related to the query are not stale (step 240), then the present statistics may be used in the development of a query plan without submitting a request to the queue.

If the DBMS does cache some plans, and if there is a cached plan related to the query (step 220), then the DBMS determines whether there are newer statistics for the cached plan (step 230). If there are newer statistics than were used in a previously cached plan, the method 200 moves to use the use the newer statistics (step 235) and proceed to develop and optimize a query plan based on the newer statistics. Alternatively, if there are no newer statistics (step 230) related to the cached plan for the query, then the DBMS moves to determine if the statistics used in the cached plan are stale (step 260). If the statistics are not stale, then the method 200 moves to execute the cached plan using the statistics that are available. Alternatively, if the statistics for the cache plan are stale (step 260), then the method 200 moves to place a request on the asynchronous queue for updated statistics related to the query (step 280). Without waiting for execution of the asynchronous request, the DBMS moves to use the cached plan with the stale statistics into execution (step 290) and return results.

According to the method 200, the “synchronous” process involved with processing a query is moved to execution using non-stale or stale statistics. In the case of using stale statistics, the asynchronous request to acquire updated requests need not be executed immediately to return results as an output of executing a query plan. In one embodiment, if subsequent query requests are received, duplicates of the update request placed on the queue are deleted. Subsequent queries which can use the same statistics can benefit from the asynchronously updated statistics if the updated statistics are available at the time a query is processed.

FIG. 2b is an example flow diagram of a method according to aspects of the invention. In the method 201, a query is received (step 211) in a DBMS. If the DBMS caches query plans, then the DBMS determines whether there is a cached query plan (step 221). If there is no caching in the system or if there is no cached plan in a cached system, the DBMS determines if an index related to the query is missing (step 241). An index may be determined as absent if there is no index associated with the table or column related to the query and if the creation of an index would improve the query performance. If the index related to the query is absent or at least incomplete, then the DBMS adds a request to the queue (step 251) to asynchronously generate the index for the relevant table and columns for the query. Without immediately generating the index, the DBMS develops and optimizes a query plan (step 271). The DBMS is then free to execute the query plan (step 291) and return results of the query. Alternately, if the index related to the query are not absent (step 241), then the present index may be used in the development of a query plan without submitting a request to the queue for creation if a new index.

If the DBMS does cache some plans, and if there is a cached plan related to the query (step 221), then the DBMS determines whether there is a newer index for the cached plan (step 231). If there is a newer index relevant to a previously cached plan, the method 201 moves to use the use the newer index (step 236) and proceed to develop and optimize a query plan based on the newer index. Alternatively, if there is no new index (step 231) relevant to the cached plan for the query, then the DBMS moves to determine if an existing index (step 261) is available. If the index is available, then the method 201 moves to execute the cached plan using the index that is available. Alternatively, if the index for the cache plan is missing or incomplete (step 261), then the method 201 moves to place a request on the asynchronous queue for creation of an index related to the query (step 281). Without waiting for execution of the asynchronous request, the DBMS moves to use the cached plan into execution (step 291) and return results.

Exemplary Computing Device

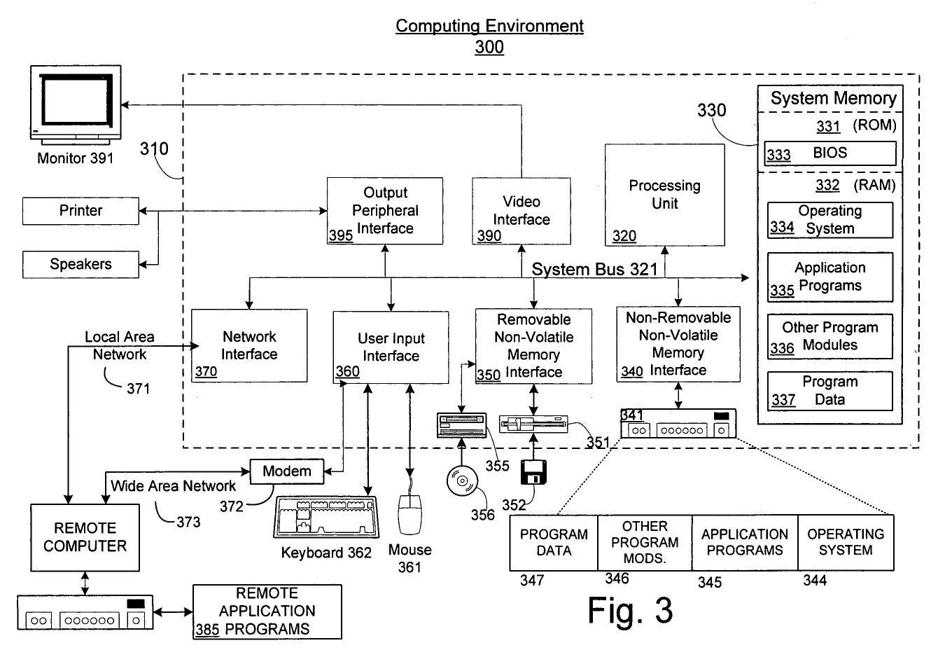

FIG. 3 and the following discussion are intended to provide a brief general description of a suitable computing environment in which embodiments of the invention may be implemented. While a general purpose computer is described below, this is but one single processor example, and embodiments of the invention with multiple processors may be implemented with other computing devices, such as a client having network/bus interoperability and interaction. Thus, embodiments of the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

FIG. 3 thus illustrates an example of a suitable computing system environment 300 in which the embodiments of the invention may be implemented, although as made clear above, the computing system environment 300 is only one example of a suitable computing environment and is not intended to suggest any limitation as to the scope of use or functionality of an embodiment of the invention. Neither should the computing environment 300 be interpreted as having any dependency or requirement relating to any one or combination of components illustrated in the exemplary operating environment 300.

With reference to FIG. 3, an exemplary system for implementing an embodiment of the invention includes a general purpose computing device in the form of a computer system 310. Components of computer system 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 310 typically includes a variety of computer readable media. Computer readable media can be any available media that can be accessed by computer system 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer system 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer system 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3 provide storage of computer readable instructions, data structures, program modules and other data for the computer system 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer system 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390, which may in turn communicate with video memory (not shown). In addition to monitor 391, computer systems may also include other peripheral output devices such as speakers 397 and printer 396, which may be connected through an output peripheral interface 395.

The computer system 310 may operate in a networked or distributed environment using logical connections to one or more remote computers, such as a remote computer 380. The remote computer 380 may be a personal computer, a server, a router, a network PC, a peer device or other common network node, and typically includes many or all of the elements described above relative to the computer system 310, although only a memory storage device 381 has been illustrated in FIG. 3. The logical connections depicted in FIG. 3 include a local area network (LAN) 371 and a wide area network (WAN) 373, but may also include other networks/buses. Such networking environments are commonplace in homes, offices, enterprise-wide computer networks, intranets and the Internet.

When used in a LAN networking environment, the computer system 310 is connected to the LAN 371 through a network interface or adapter 370. When used in a WAN networking environment, the computer system 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer system 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a method to asynchronously process statistics for a DBMS. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of an embodiment of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

What is claimed:

1. A method for performing asynchronous statistics updates in a database management system, the method comprising:
receiving a first query against a database;
determining if present statistics related to the first query are stale;
entering on a queue, a request to acquire updated statistics related to the first query if the present statistics related to the first query are stale;
developing a first query plan using the present statistics related to the first query;
executing the first query plan; and
processing the request to acquire updated statistics related to the first query asynchronously with respect to the input query.

2. The method of claim 1, wherein determining if present statistics related to the first query are stale comprises determining if the number of changes to a table associated with the first query exceed a threshold.

3. The method of claim 1, wherein the present statistics related to the first query comprise a first histogram.

4. The method of claim 1, further comprising:
receiving a second query against the database;
determining if present statistics related to the second query are stale;
entering on a queue, a request to acquire updated statistics related to the second query if the present statistics related to the second query are stale; and
eliminating duplicate requests on the queue if tables associated with the first query and the second query are similar.

5. The method of claim 1, further comprising:
receiving a second query against the database after processing the request to acquire updated statistics related to the first query asynchronously with respect to the input query;
determining if present statistics related to the second query are stale;
developing a second query plan using the updated statistics related to the first query if the second query is associated with columns of tables used in the first query such that the updated statistics related to the first query may be used for the second query plan; and
executing the second query plan.

6. The method of claim 5, wherein the updated statistics comprise a second histogram.

7. The method of claim 1, further comprising:
stopping the processing of the request to acquire updated statistics related to the first query asynchronously by killing a job representing the processing.

8. The method of claim 1, further comprising:
determining if there is a cached plan for the first query before determining if present statistics related to the first query are stale; and
using the cached plan with the present statistics related to the first query if there is a cached plan for the first query and newer statistics related to the first query are unavailable, whereby the step of developing a first query plan is avoided.

9. A system for performing database statistics updates, the system comprising;
a database management system (DBMS) for accepting and evaluating queries against a database, the DBMS having a query optimizer;
a queue for accepting asynchronous jobs entered from the optimizer;
a processor having access to memory, the memory having instructions which when executed, perform a method comprising:
receiving a first query against the database;
determining if present statistics related to the first query are stale;
entering on the queue, a request to acquire updated statistics related to the first query if the present statistics related to the first query are stale;
developing a first query plan using the optimizer and the present statistics related to the first query;
executing the first query plan; and
processing the request to acquire updated statistics related to the first query asynchronously with respect to the input query.

10. The system of claim 9, further comprising:
a counter to count the number of changes to one of a table and table column associated with the first query wherein if the counter exceeds a threshold, then the present statistics related to the first query are stale.

11. The system of claim 9, wherein the present statistics related to the first query comprise a first histogram.

12. The system of claim 9, wherein the updated statistics comprise at least one of a single histogram, single column densities, multicolumn histogram, multicolumn densities and multicolumn distinct counts.

13. The system of claim 9, further comprising the method steps:
receiving a second query against the database;
determining if present statistics related to the second query are stale;
entering on the queue, a request to acquire updated statistics related to the second query if the present statistics related to the second query are stale; and
eliminating duplicate requests on the queue if tables associated with the first query and the second query are similar.

14. The system of claim 9, further comprising:
a cache for storing execution plans;
and further comprising the method steps:
determining if there is a cached plan for the first query before determining if present statistics related to the first query are stale; and
using the cached plan with the present statistics related to the first query if there is a cached plan for the first query and newer statistics related to the first query are unavailable, and wherein the step of developing a first query plan is avoided.

15. A computer-readable medium having computer-executable instructions for performing a method for asynchronously creating indexes in a database, the method comprising:
receiving a first query against the database;
determining if an index related to the first query is missing;
entering on a queue, a request to create a first index related to the first query if the index related to the first query is missing;
developing a first query plan;
executing the first query plan; and
processing the request to create a first index related to the first query asynchronously with respect to the input query.

16. A computer-readable medium of claim 15, wherein the step of determining if an index related to the first query is missing comprises determining if an index associated with the first query is one of missing and incomplete.

17. A computer-readable medium of claim 15, the method steps further comprising:
receiving a second query against the database;
determining if an index related to the second query is missing;
entering on a queue, a request to create a second index related to the second query; and
eliminating duplicate requests on the queue if tables associated with the first query and the second query are similar.

18. A computer-readable medium of claim 15, the method steps further comprising:
receiving a second query against the database after processing the request to create a first index related to the first query asynchronously with respect to the input query;
determining if an index related to the second query is missing;
developing a second query plan using the first index related to the first query if the second query is associated with columns of tables used in the first query such that the first index related to the first query may be used for the second query plan; and
executing the second query plan.

19. A computer-readable medium of claim 15, the method steps further comprising:
stopping the processing of the request to create a first index related to the first query asynchronously by killing a job representing the processing.

20. A computer-readable medium of claim 15, the method steps further comprising:
determining if there is a cached plan for the first query before determining if an index related to the first query is missing; and
using the cached plan wherein the step of developing a first query plan is avoided.
